(19) United States
(12) Patent Application Publication
(10) Pub. No.: US 2004/0088238 A1
(43) Pub. Date: May 6, 2004

(54) Method and system for monitoring electronic transactions

(76) Inventors: Kevin Gilson, Commack, NY (US); Dan Lyons, Greenlawn, NY (US); Stephen Trachtulec, Garden City, NY (US); Michael Hamian, Commack, NY (US); Barbara Marx, Kings Park, NY (US); Kevin McCarthy, Dix Hills, NY (US); Tom Robbins, Deer Park, NY (US); Walt Dill, Hagerstown, MD (US); Joe Dandrilli, West Islip, NY (US)

Correspondence Address: Gregory P. Silberman, Kaye Scholer LLP, 425 Park Avenue, New York, NY, 10022, US

(21) Appl. No.: 10/286,667

(22) Filed: Nov. 1, 2002

(51) Int. Cl. G06F 17/60

(52) U.S. Cl. 705/35

(57) ABSTRACT

A method and system for monitoring electronic transactions, such as credit card transactions, to determine whether associated transaction costs, such as interchange fees, are being properly qualified. This is accomplished by monitoring for a “spike” in interchange qualifications and generating an alert when one or more spikes are detected. Spikes in interchange qualifications are defined as a variation in interchange qualifications compared with an historical level. The method and system may also monitor changes in cost or efficiency for other types of transactions in which the cost or efficiency of the transaction is based directly upon one or more variables.

### FIELD OF THE INVENTION

The invention relates to automated transaction monitoring systems and methods, and more particularly to a system and method for monitoring costs and efficiency associated with electronic transactions.

### BACKGROUND OF THE INVENTION

Each time a credit card purchase is processed, fees are imposed upon the merchant involved in the transaction. One such fee that is applied to the merchant who is a party to a credit card purchase is known as interchange. Interchange is revenue paid by merchants that have received a credit card payment to banks that have issued the credit card used in the transaction (“issuing banks”). Because interchange fees are a business expense incurred by merchants, it is desirable to such merchants to keep their respective interchange fees to a minimum.

The interchange fee for a given credit card purchase is based upon the manner in which the credit card transaction is processed, and therefore varies from merchant to merchant and often from transaction to transaction (even when the same merchant is involved). Typically, when a credit card purchase is effectuated in a manner that tends to increase the reliability of the transaction, the lower the interchange rate that is applied to the transaction. Alternatively, if a greater risk is associated with the transaction, the higher the interchange rate that is applied. Two factors that affect the reliability of a credit card transaction is the accuracy of the data inputted by the merchant (e.g., credit card number, expiration date, etc.) and the timeliness in which the data is transmitted to the issuing bank.

For example, the amount of time that transpires between when a credit card purchase occurs and when the merchant makes a request for payment authorization by the issuing bank affects the interchange rate—i.e., the shorter the duration of time, the more favorable the interchange rate may be. In addition, the manner in which a merchant inputs a purchaser's credit card information also affects the interchange rate—e.g., if the data is entered directly from the magnetic strip of a credit card (by, for example, swiping the purchaser's card), the interchange rate is lower than if the information is entered manually by a representative of the merchant.

The interchange fee may also vary due to processing error caused by a merchant, bank or entity that executes the credit card transaction on behalf of the merchant and credit card association (i.e., the data transaction provider). For example, a merchant may realize a less favorable interchange rate due to delay or inaccuracies in transaction processing resulting from, for example, telecommunications error, software error, etc. caused by the system of the merchant. Such errors usually result in higher fees incurred by the merchant. In another instance, a merchant may realize a less favorable rate due to an error caused by another party involved in the transaction—e.g., bank, transaction data processor, etc.—which may or may not be recoverable by the merchant.

### SUMMARY OF THE INVENTION

Increases in interchange fees result, in some instances, from the manner in which the parties involved in a credit card transaction chooses to execute the transaction, and in other instances, from inadvertent processing errors caused by one or more of the parties involved in the transaction and/or the equipment used therein. By identifying an increase (or “spike”) in unfavorable interchange qualifications resulting from processing errors, interchange fees incurred by the parties may be reduced, and in some instances may even be reversed. In addition, detecting the source of such spikes also enables, in certain instances, the resulting costs to be shifted to the party that has caused the error.

It is therefore desirable to have an effective system and method for determining when spikes in interchange qualifications are imposed over a predetermined period of time, and for identifying the entity (e.g., merchant, acquiring bank, data transaction provider, etc.) causing such spikes.

This is accomplished by monitoring transaction costs for a plurality of transactions completed during a period of time. Upon receiving data relating to the costs associated with the transactions completed during the period of time, qualification category cost data is identified, and the qualification category cost data is assigned to various level codes. The qualification cost data for the period of time is then compared with associated historical qualification cost data, for each of the level codes. A determination is then made as to whether current transaction costs as compared to historical transaction costs vary by more than a predetermined threshold for at least one of the level codes. By identifying such variance(s) and the associated level code(s) for which the variance occurred, interchange spikes and their source can be effectively detected.

The inventive method and system also monitors changes in costs or efficiency for other types of electronic transactions in which the cost or efficiency of the transaction is based directly upon one or more variables. The method and system may monitor the efficiency of transactions by receiving efficiency data (such as transaction cost, transaction time) relating to at least one transaction, comparing the efficiency data to a predefined target transaction efficiency, and generating an alert based upon a variation of the efficiency of the transaction as compared to the predefined target transaction efficiency. A determination is then made as to whether the received efficiency data as compared to historical transaction costs vary by more than a predetermined threshold. By identifying such variance(s), changes in transaction efficiency and the source of such changes can be effectively detected.

### BRIEF DESCRIPTION OF THE DRAWINGS

Further objects, features and advantages of the invention will become apparent from the following detailed description taken in conjunction with the accompanying drawings showing illustrative embodiments of the invention, in which:

FIG. 1A is a diagram illustrating the interrelationship between parties involved in a credit card transaction;

FIG. 1B is a diagram illustrating the interrelationship between parties involved in processing interchange resulting from credit card transactions;

FIG. 2 is a diagram of a system for monitoring spikes in interchange rates in accordance with one embodiment of the invention;

FIG. 3 is a block diagram of a data storage device and components of a server used in the system of FIG. 2;

FIG. 4 is a flowchart illustrating the process of generating an alert resulting from one or more interchange rate variations in accordance with one embodiment of the invention;

FIG. 5 depicts examples of levels of detection of an interchange rate variation in accordance with one embodiment of the invention; and

FIGS. 6A and 6B are graphical user interfaces illustrating examples of alerts resulting from one or more interchange rate variations in accordance with one embodiment of the invention.

### DETAILED DESCRIPTION

The invention is directed to a method and system for monitoring electronic transactions, such as credit card transactions, to determine whether associated transaction costs, such as interchange fees, are being properly qualified. As described below, this is accomplished by monitoring for a “spike” in interchange qualifications and generating an alert when one or more spikes are detected. Spikes in interchange qualifications are defined as a variation in interchange qualifications compared with an historical level. As further described below, the method and system may also monitor changes in costs or efficiency for other types of transactions in which the cost or efficiency of the transaction is based directly upon one or more variables.

Credit Card Settlement Process

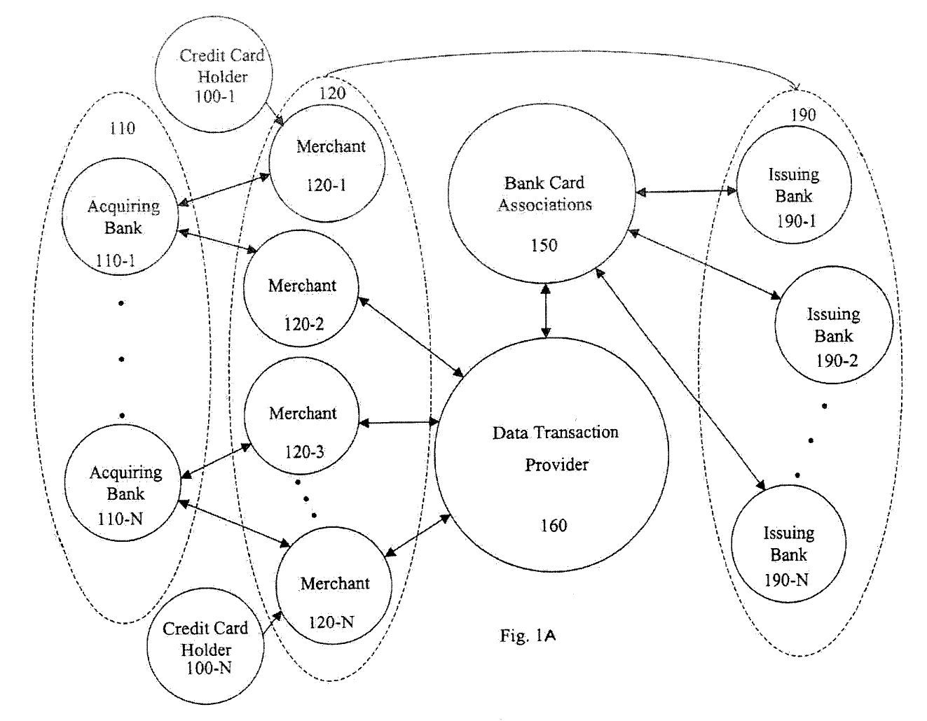

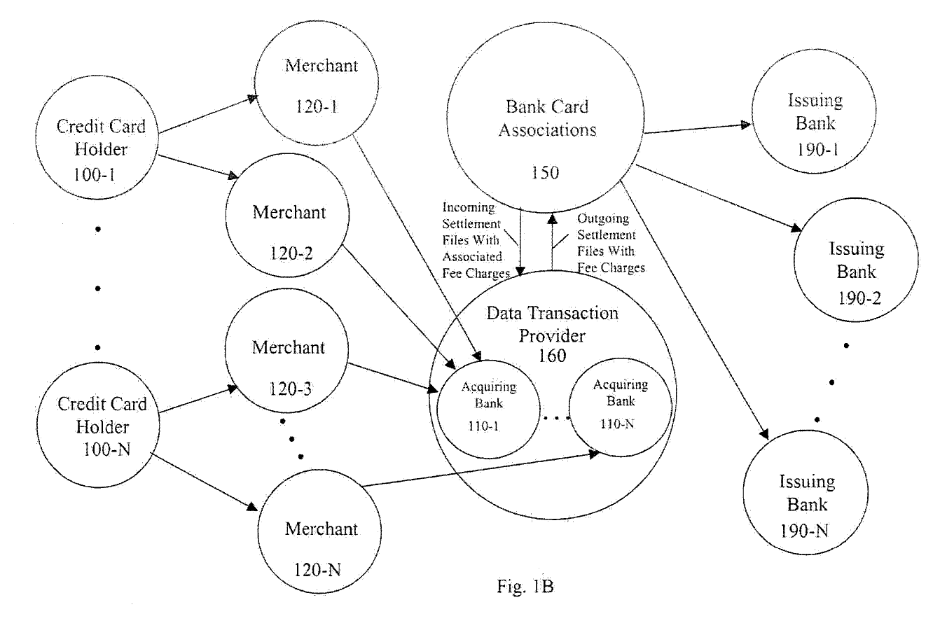

When a credit card transaction is processed, data required to effectuate (or settle) the transaction is entered, a request for authorization to complete the transaction (based on the transaction data) is generated, an authorization is either granted or denied, and if authorization is granted, necessary funds to effectuate the transaction are transferred. Such a transaction typically involves multiple parties (including credit card holders 100-1 through 100-N, acquiring banks 110-1 through 110-N, merchants 120-1 through 120-N, bank associations 150, data transaction provider 160 and issuing banks 190-1 through 190-N), the interrelationship of which are illustrated in FIG. 1.

Credit card holders 100 are persons that purchase goods or services from merchants 120 using a credit card issued by issuing bank 190-1. Merchants 120 are persons or entities that sell goods or services and are able to accept and charge credit cards to complete the sale.

Acquiring banks 110 are entities associated with one or more of merchants 120 and effectuate payment to such merchants 120 upon authorization of a credit card transaction, and charges merchants 120 a fee for handling each transaction. Issuing banks 190 are entities that issue credit cards to approved card holders, receive and pay for transactions from bank card associations 150 and send bills to and collect payment from the credit card holder.

Bank card associations 150 are credit card payment service associations (such as Visa and MasterCard) that are made up of member financial institutions. Bank card associations 150, among other things, set and enforce rules governing their credit cards and conduct clearing and settlement processing. In addition, bank card associations 150 maintain national and international networks through which data funds are moved between credit card holders, merchants 120 acquiring banks 110 and issuing banks 190.

It should be noted that bank card associations 150 neither issue cards nor sign merchants. Instead, they license financial institutions to issue cards and/or acquire merchants' sales drafts under the association's brand name. The association then manages the transfer of transaction data and funds between issuing and acquiring members, creating an infrastructure that is called an “interchange” system.

Data transaction provider 160 serves as the liaison between merchants 120 and bank card associations 150. Provider 160 computes the interchange associated with each credit card transaction processed by merchants 160 in accordance with predetermined business rules (described more fully below) established by bank card associations 150.

Thus, suppose a credit card holder 100-1 makes a $50.00 purchase at merchant 120-1 using a credit card that was issued by issuing bank 190. Upon inputting transaction data, merchant 120-1 requests authorization from data transaction provider 160, a bank card association 250 and ultimately issuing bank 190-1. The request for authorization is transmitted from merchant 120-1 to issuing bank 190-1 through data transaction provider 160 and bank card associations 150. The resulting authorization (or rejection) is then issued by issuing bank 190-1 and transmitted back to merchant 120-1 through bank card association 150 and data transaction provider 160.

Upon completion of the transaction, merchant 120-1, at some subsequent point in time, is paid the transaction price by acquiring bank 110-1 which receives payment from issuing bank 190-1. The bank card association 150 associated with the credit card holder's credit card and data transaction provider 160 receive the data (i.e., interchange data) concerning the transaction to, among other things, establish an interchange qualification category respecting the transaction based on transaction data, merchant type, etc. as described below. As a result of the interchange qualification category, an interchange fee is determined and paid by merchant 120-1 to issuing bank 190-1.

Interchange Payment Process

Interchange (or interchange fee) is revenue that is paid to the issuing banks 190 (for a given bank card association 150) by the merchants 120 who have received payment for goods by credit card holders 100 with one of the issuing bank's credit cards. FIG. 1B illustrates the process for payment of such interchange.

When a credit card holder, say holder 100-1, makes a purchase from merchant 120-1, data transaction provider 160 qualifies the transaction to determine the interchange fee for such transaction (as described below). The interchange fee is then paid by merchant 120-1 to data transaction provider 160 through, for example, acquiring bank 110-1. In one embodiment, an acquiring bank may be a partner of data transaction provider 160. In another embodiment, an acquiring bank may subcontract the processing of the transaction. In either case, the transactions are sent by the merchant 120-1 to the data transaction provider 160 on behalf of acquiring bank 110-1. This may be accomplished by, for example, the merchants themselves or by third party processors.

The credit card-transaction and interchange data (or settlement files with fee charges) are transmitted by data transaction provider 160 to bank card association 150. Bank card association 150 then makes its own determination of the interchange fee for the transaction. Bank card association 150 informs data transaction provider 160 of the interchange fee for the transaction and this amount is retrieved from data transaction provider for payment to issuing bank 190-1. Thus, the interchange fee paid by merchant 120-1 to data transaction provider 160 through acquiring bank 110-1 is ultimately paid to issuing bank 190-1 through bank card association 150.

Interchange Rate and Qualification

As described above, interchange is revenue that is paid to issuing banks 190 (for credit card associations 150) by merchants 120 who have received payment for goods with one of the issuing bank's 110 credit cards. Bank card associations 150 have many interchange programs for each industry (e.g., retail, supermarkets, hotels, car rentals, etc.) with different rates. When a credit card transaction is processed, there are many fields and qualification criteria that must be calculated correctly in order to qualify for the most favorable interchange rate. If these fields and criteria are not accurate, the transactions will not clear at the most favorable rate. The fields and qualification criteria that establish the interchange rate are referred to herein as the bank card association's 150 business rules. These interchange rates are tied to the risk associated with a particular credit card transaction, and may be assessed at a higher rate for many reasons. For example:

Where a merchant 120 waits longer than a predetermined amount of time to complete a credit card transaction, the interchange qualification may be adversely categorized and the resulting rate may increase.

If the merchant's 120 telecommunication equipment is faulty and prevents automated authorization of the credit card transaction, the interchange qualification may be adversely categorized and the resulting rate may increase.

If the merchant enters the credit card data manually, as opposed to an electronic reading of the credit card information, the interchange qualification may be adversely categorized and the resulting rate may increase.

If the transaction fields (such as credit card number, transaction date, transaction price, authorization data, etc.) are not accurately populated, the interchange qualification may be adversely categorized and the resulting rate may increase.

The interchange monitoring system described below receives interchange cost data respecting recent credit card transactions, including interchange qualification ratings for such transactions based on the received data, compares such qualifications and qualification costs with associated historical interchange data and determines whether a spike has been detected. By generating an alert upon detection of such a spike, acquiring banks 110, merchants 120 and data transaction providers 160 can effectively identify the source, or entity (e.g., acquiring bank 110, merchant 120, data transaction provider 160, etc.) that may have caused the spike.

Interchange Monitoring System

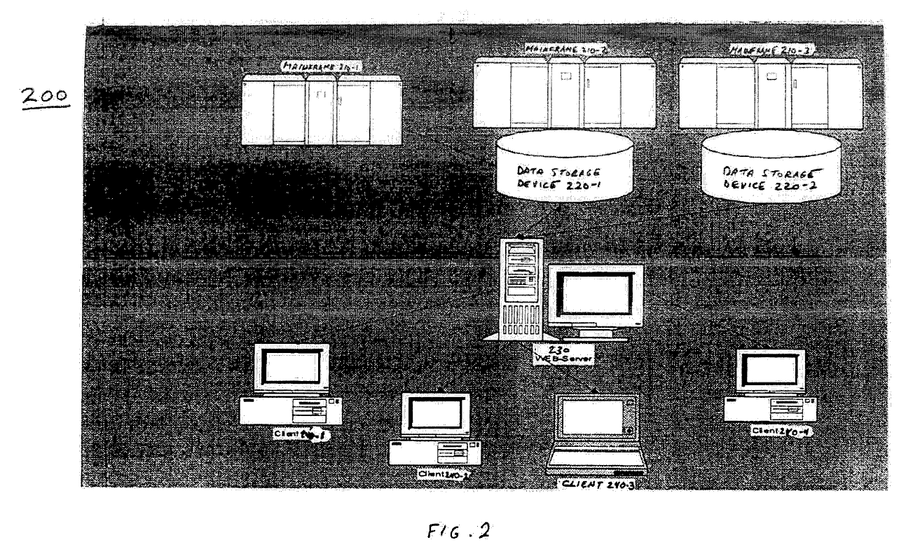

FIG. 2 shows an interchange monitoring system (IMS) 200 for receiving interchange qualification and qualification cost data from a plurality of merchants 120 and for evaluating the interchange data, at various levels (as described below), against associated historical data. As discussed further below, upon receiving data resulting from credit card transactions, IMS 200 monitors the interchange qualifications respecting such transactions and compares groupings of qualifications, by various levels, with associated historical interchange qualifications to determine whether spike(s) in interchange qualifications have occurred.

As shown in FIG. 2, IMS 200 preferably includes one or more mainframes (or servers) 210 which are in communication with one or more data storage devices 220. Each mainframe 210 may be remotely located from data storage devices 220 (such as mainframe 210-1) or may be integrated (such as mainframes 210-2, 210-2) with storage devices 220. As described further below, the data stored on data storage devices 220 is information that is used to determine whether an interchange spike has occurred. Such data may be accessed, in one embodiment, by using IBM's DB2 database software. In an alternate embodiment, another relational database software application may be used to effectuate the integration between mainframes 210 and data storage devices 220.

The data stored by storage devices 220 is also accessed by web server 230 which uses such data to generate graphical user interfaces (GUI's) for display of reports including alerts when interchange spikes are detected. In a preferred embodiment, web server 230 uses Microsoft's NT operating system, and the reports and alerts that are generated are web-based for access by user interface devices 240.

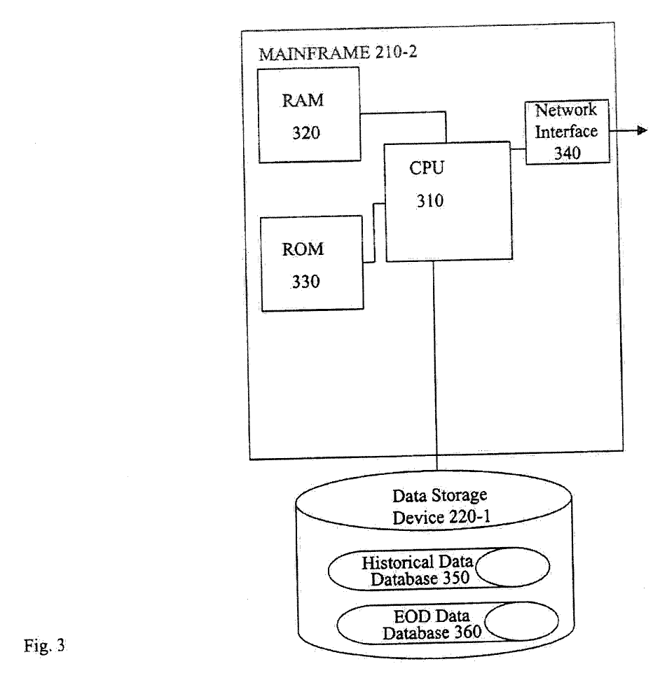

FIG. 3 is a block diagram showing the architecture of one of the mainframes used by IMS 200 (mainframe 210-2) in communication with data storage device 220-1. Mainframe 210-2 preferably includes standard hardware components, such as central processing unit (CPU) 310, a random access memory (RAM) 320, a read only memory 330 and communications port 340. The CPU 310 is preferably linked to each of the other listed elements, either by means of a shared data bus, or dedicated connections, as shown in FIG. 2.

CPU 310 may be embodied as a single commercially available processor. Alternatively, in another embodiment, the CPU 310 may be embodied as a number of such processors operating in parallel.

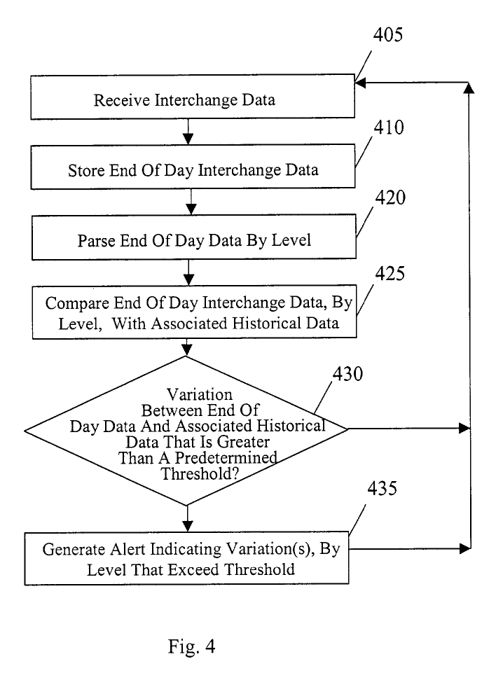

ROM 330 is operable to store one or more instructions, discussed further below in conjunction with FIG. 4, which the CPU 310 is operable to retrieve, interpret and execute. For example, ROM 330 preferably stores processes to receive, parse and compare interchange data as described below.

CPU 310 preferably includes a control unit, an arithmetic logic unit (ALU), and a CPU local memory storage device, such as, for example, a stackable cache or a plurality of registers, in a known manner. The control unit is operable to retrieve instructions from the ROM 330. The ALU is operable to perform a plurality of operations needed to carry out instructions. The CPU local memory storage device is operable to provide high-speed storage used for storing temporary results and control information.

Data storage device 220-1 includes, in one embodiment historical data database 350 and an end-of-day (EOD) data database 260. Historical data database 350 preferably stores information relating to historical interchange data for a predetermined time (e.g., twelve months into the past). In addition, EOD data database 360 preferably stores information relating to recently generated interchange data that is being monitored for one or more spikes in interchange qualifications.

Communication port 340 connects the mainframe 210-2 to web server 230 which is in communication with client/user interface devices 240. The communication port 340 connects mainframe 220-1 to web server 230 by means of a TCP/IP connection using a wide area network.

Interchange Monitoring Process

The interchange monitoring and alerting process that is effectuated by system 200 is illustrated in FIG. 4.

At step 405, IMS 200 receives interchange data for storage by one or more of data storage devices 220. Interchange data is the credit card processing information that is used by a merchant 120, acquiring bank 110, issuing bank 190, bank card associations 150 and data transaction processor 160 to effectuate a credit card transaction. This information includes identification information, such as the credit card holder's name, the holder's credit card number and expiration date. The processing information also includes data identifying the acquiring bank 110 and issuing bank 190 that are involved in the transaction. The processing information further includes transaction information, including the sales amount involved in the transaction, authorization codes, number of days between transaction date and authorization date, number of days to settle the transaction, and merchant type (e.g., industry). The timeliness of the transaction, accuracy of the data, type of merchant and type of authorization (e.g., electronic at time of transaction) contribute to the interchange rate that is incurred by merchant 120 for each transaction.

Data storage devices 220 typically receive and store (step 410) two sets of interchange data (i.e., historical interchange data and EOD interchange data), the comparison of which provides an indication of spikes in one or more groupings, or levels, of interchange qualifications. The EOD interchange data comprises recently generated interchange data for which spikes are being monitored. In one embodiment, the EOD interchange data includes the interchange data that was received by IMS 200 from merchants 120 within the past day—e.g., from the 12:00:00 AM to 11:59:59 PM time period of the previous day. In another embodiment, the period of time may vary to include two or more days' worth of data, a portion of a day's worth of data or the data of some other recent preceding period of time for which interchange qualification variations are to be monitored. Historical interchange data, however, includes interchange data that has been received prior to the period of time for which interchange qualification variations are being monitored. In one embodiment, the duration of time for which historical interchange data is stored in data storage devices 220 is twelve months.

As EOD interchange data is received, data transaction provider 160 qualifies each credit card transaction resulting in a transaction interchange qualification. As described above, the qualification is tied to, among other things, the timeliness of the transaction, accuracy of the data, type of merchant and type of authorization involved. As a result of the qualification, each credit card transaction is assigned an interchange qualification category (also called a plan code). The qualification category data is stored by data storage device 220 for comparison with historical information.

There are many interchange qualification categories established by bank card associations 160. For example, Visa assigns category, “CPS Retail Rate” (an interchange rate of 1.37% of the transaction+$0.10), to a transaction where a Visa card transaction takes place at a retail outlet merchant, in which the transaction settles within 2 days, the authorization is valid and requested and provided electronically, a validation code is present and the card is read electronically (by swiping the credit card). If the same transaction, however, involved a three day settlement, the category would be an “Electronic Interchange Reimbursement Fee” or “EIRF” (an interchange rate of 2.0% of the transaction+$0.10).

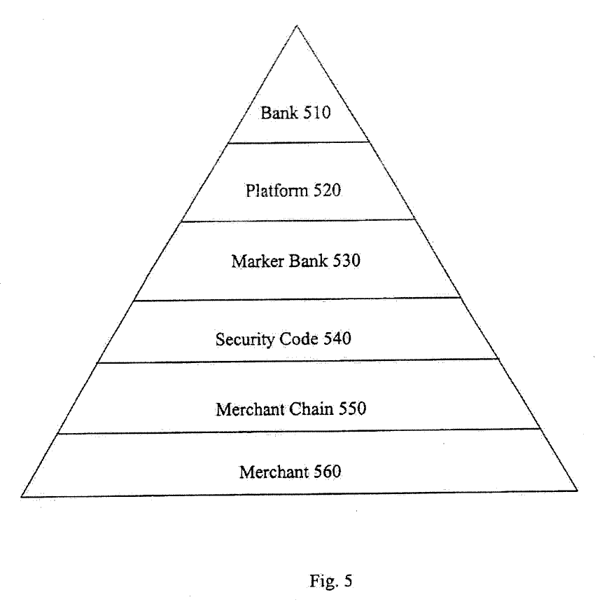

After the EOD interchange data has been received for a given period (e.g., a day) for which interchange qualification spikes are to be monitored, and an interchange qualification category has been assigned for each transaction, certain interchange data and the interchange qualification category associated with each transaction are assigned (or parsed) to various groupings, or levels (step 420). These levels are illustrated in FIG. 5, and assist in the alert process as they enable a user of IMS 200 to effectively identify the source of a spike when one occurs.

Thus, when an interchange qualification category is assigned to a credit card transaction, the category and associated transaction amount are also assigned to codes of various levels as follows: acquiring bank level 510, platform level 520, marker bank level 530, security code level 540, merchant chain level 550 and merchant level 560.

At merchant level 560, interchange qualification category and associated sales amount information are assigned to a merchant identification code for each interchange qualification.

In addition, a merchant chain code is established for each group of related merchants 120. In instances where a merchant 120 is a person or a single entity, the merchant level 560 and merchant chain level 550 receive the same data. However, if a merchant 120 comprises multiple entities or associations of persons, these multiple entities/associations are grouped together as a merchant chain. Accordingly, at the merchant chain level 550, all interchange qualification category and associated sales amount information are also assigned to the merchant chain identification code for each interchange qualification.

Each transaction is also assigned to security code level 540. The security code level 540 may comprise multiple codes which are defined by the manner in which interchange data is transmitted from merchant 120 to data transaction provider 160. For example, if the data is electronically transmitted directly from merchant 120 to transaction provider 160, the interchange qualification category and associated sales amount arising from the transaction is assigned to a security code defined as such. Whereas, if the data is transmitted from merchant 120 to data transaction provider 160, through a third party, then the interchange qualification category and associated sales amount arising from the transaction is assigned to a different security code defined as such.

Each transaction is also assigned to a bank level 510, platform level 520 and marker bank level 530. For example, at the bank level 510, codes are established for each acquiring bank 190 that acquired the credit card transaction on behalf of merchant 120 for which an interchange qualification category has been assigned. Accordingly, all interchange qualification category and associated sales amount information are assigned to an acquiring bank identification code for each interchange qualification.

The platform level 520 relates to pre-specified portions of processing resources of mainframe 210 which are designated to handle interchange qualifications for specific acquiring banks 190, and in some cases large merchants or merchant chains. Thus, at the platform level 520, codes are established for portions of mainframes 210. When interchange is qualified for a transaction, the resulting interchange qualification category and associated sales amount information are assigned to the platform code associated with the mainframe portion that processed the qualification.

At the marker bank level 530, codes are established for subsidiaries, divisions and related organizations of acquiring banks 110. In instances where an acquiring bank 110 has no subsidiaries, divisions or related organizations that handle credit card transactions, the bank level 510 and marker bank level 530 receive the same data. However, if an acquiring bank 110 has one or more subsidiaries, divisions or related organizations that handle credit card transactions, each of these sub-entities are assigned its own marker bank code but are also grouped together and assigned a bank code for association with the resulting interchange qualification category and associated sales amount information.

As an illustrative example, suppose that a Visa card holder makes a $50.00 credit card purchase at a clothing store, The Gap, which is a merchant that is part of a merchant chain, also called The Gap. Further, suppose that the acquiring bank is Citibank which is a subsidiary of Citigroup. When the merchant (The Gap), for example, swipes the card holder's credit card, transactional data related to interchange qualifications is generated and, in this example, is transmitted ultimately to data transaction provider 160 and the card holder's issuing bank 190. In addition to recognizing the manner in which the transaction data was generated (i.e., by swiping the card), data transaction provider 160 receives additional interchange information, such as, in this example, that the authorization was received within one day of the transaction, that the transaction settled within two days, and that an appropriate validation code and authorization were generated. When the interchange data is received, data transaction provider 160 qualifies the transaction. Assuming that no errors occur, the interchange qualification for the scenario described above would be a favorable interchange retail qualification category called, “CPS Retail”.

Once this interchange data has been received and qualified by data transaction provider 160, the interchange qualification category (i.e., CPS Retail Rate) and associated transaction amount (i.e., $50.00) are assigned to the levels described above. So, in this instance, the interchange data and associated transaction amount are assigned to a merchant code associated with the specific Gap merchant as well as merchant chain code associated with The Gap chain. In addition, because the transaction data was received by the transaction provider directly from The Gap merchant, the interchange data and associated transaction amount are assigned to the security code 540 associated with such direct transmission. Further, the interchange data and associated transaction amount are assigned to the code of marker bank level 530 associated with Citibank, the code of platform level 520 associated with the mainframe platform that handles Citibank transactions and the code of bank level 510 assigned to Citigroup.

Returning to FIG. 4, once EOD qualification category data and associated interchange data for a given period of time has been received and stored (steps 405, 410), and the resulting-interchange qualifications have been parsed and cumulated by levels 510-560 (step 420), processor 310 then compares the EOD interchange qualification data, by level, with the associated historical interchange qualification data, which is also available by level (step 425), for each bank 510, platform 520, marker bank 530, security code 540, merchant chain 550 and merchant 560. In one embodiment, the historical interchange qualification data that is used for comparison with the EOD interchange data is a running average of such data for the previous eight weeks, for the same day of the week. So, for example, if the EOD interchange qualification data comprises transaction data for credit card transactions that took place on a Sunday, the historical interchange data would be the average of interchange data for the appropriate code at each level for the previous eight Sundays. It would be appreciated that other statistical samplings of the historical interchange data may be used by IMS 200 for comparison with EOD interchange qualification data.

CPU 310 then determines whether any spikes occurred—i.e., variations between the EOD interchange qualification data, by level code, and the associated historical interchange qualification data, by level code, that is greater than a predetermined threshold (step 430). The thresholds for generating an alert may be tied to the variation in the number of transactions that were assigned to a specific interchange category for a specific level code, or may be tied to variations in the transaction amounts assigned to a specific interchange category for a specific level code, or may be tied to both.

In addition, the threshold may vary from level code to level code. For example, where a large bank is involved in credit card transactions and the number of daily transactions are on the order of hundreds of thousands, a threshold respecting a 1 percent variation, for example, may be acceptable, whereas a 10 percent variation may be appropriate for a small merchant that handles only approximately 100 transactions in a given day.

If no spikes are detected, the process returns to the beginning (step 405) and continues to receive EOD interchange data for qualification, parsing and comparing with associated historical data. If, however, one or more spikes are detected, corresponding alerts are generated indicating that variations, by level code, exist which exceed a predetermined threshold (step 435). Upon generating the alert(s), the process returns to the beginning (step 405) and continues to receive EOD interchange data for qualification, parsing and eventually comparing with associated historical data.

Generation of Alerts

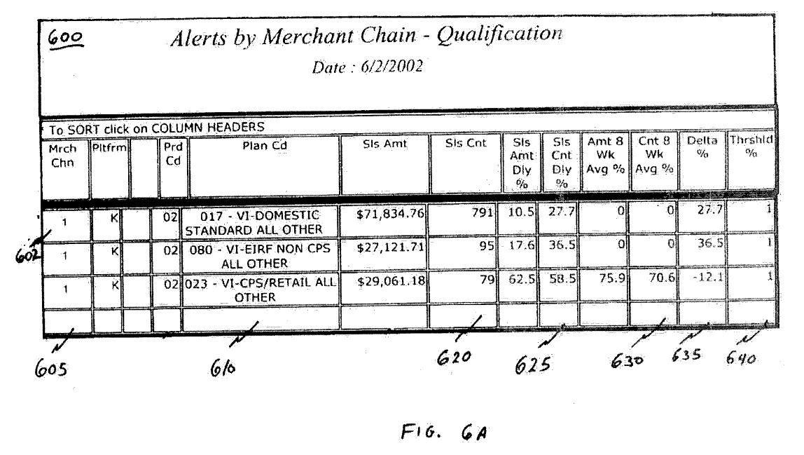

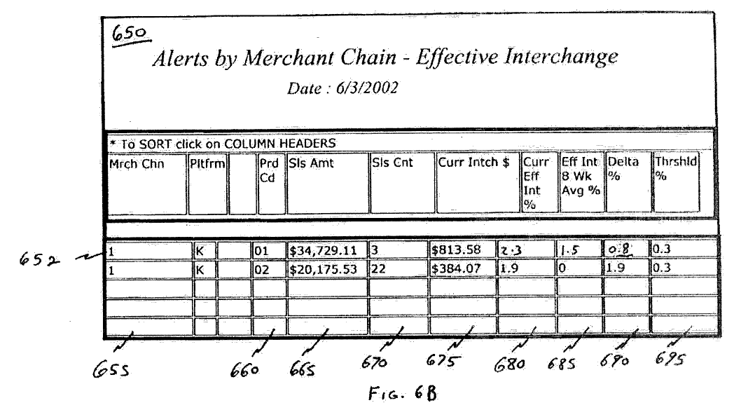

Portions of GUI's generated by web server 230 for the display of reports indicating an alert for each interchange spike that is detected are illustrated in FIGS. 6A and 6B. Each row displayed in these reports under the header row relates to an alert. The alerts function as a roadmap which allow users of IMS 200 to effectively pinpoint the cause of interchange qualification spikes. For example, users may review reports for alerts that show acquiring banks, platforms, marker banks, security codes, merchant chains and merchants that are causing interchange spikes. Users, after reviewing the alerts, may then narrow their focus to specific spikes to identify the root cause by “drilling” down to merchant detail.

FIG. 6A illustrates a portion of a GUI displaying alerts generated due to interchange spikes associated with the variance between EOD interchange qualification data and average historical interchange qualification data respecting credit card transactions that cleared under varying interchange qualification categories by merchant chain. This screen summarizes sales and transaction data at the merchant chain level 550 for merchant chain code number 1 (column 605) and displays the interchange categories (column 610) for which spikes were experienced in excess of 1% for that interchange category. The historical interchange qualification data used is the prior 8-week average transaction counts (column 630) for the same day of the week as the current interchange qualification shown in column 620.

In report 600, merchant chain number 1 experienced an increase of 27.7% (column 635) in Visa transaction volume clearing at the interchange qualification category, “Domestic Standard” (column 610). As shown in the daily sales count and daily sales percentage columns (columns 620 and 625, respectively), based on the EOD interchange qualification data received by IMS 200, 791 transactions, or 27.7% of the transactions that were completed on Jun. 2, 2002 by merchant chain number 1, were categorized under the “Domestic Standard” interchange qualification category. Based on the historical interchange qualification data, however, 0% of the transactions completed by merchant chain number 1 for the previous 8-week period (for the same day of the week) cleared at this interchange qualification rate (column 635). Report 600 therefore indicates a 27.7% interchange spike (column 635) associated with merchant chain number 1. Because the 27.7% spike is greater than the predetermined 1% threshold (column 640), the alert displayed in row 602 of report 600 is generated.

It should be noted that a report displaying alerts by merchant, instead of merchant chain, would in this case display the same information as shown in by report 600, except that information would be displayed by merchant code, not merchant chain code. Such a report would display the individual merchant location(s) that caused the interchange spikes for each interchange level that varied by more than the predetermined threshold.

FIG. 6B illustrates a portion of a GUI displaying alerts generated due to interchange spikes associated with a variation between EOD interchange qualification data and average historical interchange qualification data respecting the effective interchange rates for credit card transactions that cleared by merchant chain number 1. Effective interchange rate is defined as interchange cost for a group of transactions divided by the total sales of such transaction Report 650 summarizes sales (column 665) and transaction count data (column 670) at the merchant chain level 550 for a given interchange qualification category and displays the spikes experienced by merchant chain number 1 (column 655), defined by a variation in effective interchange rate in excess of 0.3% in this instance (column 695).

In report 650, merchant chain number 1 experienced an increase of 0.8% (column 690) in its effective MasterCard interchange rate as displayed by the product code column 660. As shown in sales amount column 665, based on the EOD interchange qualification data received by IMS 200, the effective interchange rate resulting from credit card transactions for chain number 1, at the product code level 01, was 2.3% of the sales amount of such transactions (column 680). This rate is calculated by dividing EOD interchange data for merchant code number 1 clearing at a product code (01) by the associated sales amount for such merchant and product code. Based on the historical interchange qualification data, however, the effective interchange rate for merchant chain number 1 clearing at product code 01 for the previous 8-week period (for the same day of the week) was 1.5% (column 685). Report 650 therefore indicates a 0.8% interchange rate spike associated with merchant chain number 1 for that product code (column 690). Because the 0.8% interchange rate spike is greater than the predetermined 0.3% threshold (column 695), the alert in row 652 displayed by report 650 is generated.

It should be noted that other reports may be generated, including reporting alerts by security codes, marker banks, platforms and portfolio banks.

The foregoing merely illustrates the principles of the invention. It will thus be appreciated that those skilled in the art will be able to devise numerous other arrangements which embody the principles of the invention and are thus within its spirit and scope. For example, although IMS 200 shows three mainframes 210 and two storage devices, etc., it would be appreciated that a larger or smaller number of these components may be used to effectuate the processes described herein. Further, storage devices 220 may be situated internal or external to such mainframes 210.

The monitoring method and system described above relates to monitoring changes in costs resulting from a plurality of credit card transactions. It should be noted that one skilled in the art may apply a similar method and system for monitoring changes in transaction costs or efficiency for many other types of transactions in which the cost or efficiency of the transaction is based directly upon one or more variables. The method and system may monitor the efficiency of transactions by receiving efficiency data (such as transaction cost, transaction time) relating to at least one transaction, comparing the efficiency data to a predefined target transaction efficiency, and generating an alert based upon a variation of the efficiency of the transaction as compared to a predefined target transaction efficiency.

In an embodiment of the invention, the predefined target transaction efficiency may be based upon historical transaction efficiency data. In addition, the efficiency may be measured, for example, in terms of time to conduct the transactions or cost to conduct at least one transaction. As described above, an alert is generated when the variation is greater than a threshold, which may be a function of a predetermined number of transactions for which the associated efficiency varies with the predefined target transaction efficiency or a predetermined minimum amount of variation in efficiency of at least one transaction as compared to a predefined target transaction efficiency. Further, a report may be generated for indicating each alert generated and the report may be manipulated to facilitate identification of at least one entity responsible for causing the variation.

For example, in the field of package or mailing delivery services, various charges and delays are imposed depending on certain criteria, such as the size and weight of the item(s) being delivered, the destination, the time in which delivery is requested, the day of the week for which delivery is requested, etc. By comparing the costs of deliveries for a given period as compared to a previous period of time, the monitoring method and system described above can be easily adapted to detect variations in such transaction costs and identify sources and, in some instances, causes of such variations. In this example, it may be detected that, due to delays in getting packages ready for shipment, for example, the use of expedited shipping at a higher cost is necessitated or that deliveries are not being made in a timely manner. This may be accomplished by effectuating the comparisons, and generating the alerts and reports described above.

Another example relates to the fulfillment of parts orders. Variations in transaction costs and delivery times for a current period as compared to a past period of time for such order placement and fulfillment may be compared, and alerts may be generated if the variance exceeds a certain threshold. In this example, the inventive system and method could identify increased costs incurred by not allowing adequate lead times for the delivery of necessary components or charges incurred for not using a proper electronic data interchange format. In addition, reports may be generated to assist in identifying the source and, in some instances, cause of such variances that exceed a given threshold.

What is claimed is:

1. A method for monitoring costs associated with at least one transaction, comprising:
receiving a set of data relating to at least one transaction;
identifying the cost of the at least one transaction based on said set of data; and
generating an alert based upon a variation of the cost of the transaction as compared to a predefined target transaction cost.

2. The method of claim 1, wherein the predefined target transaction cost is based upon historical transaction cost data.

3. The method of claim 1, wherein the predefined target transaction cost is based upon an average of transaction cost data for a period of time.

4. The method of claim 3, wherein the average is determined by transaction cost data generated on a predetermined day of a week for the preceding period of time.

5. The method of claim 1, wherein the alert is generated when the variation is greater than a threshold.

6. The method of claim 5, wherein the threshold relates to a predetermined number of transactions for which the associated costs varies with the predefined target transaction cost.

7. The method of claim 5, wherein the threshold relates to a predetermined minimum amount of variation in cost of the at least one transaction as compared to a predefined target transaction cost.

8. The method of claim 1, further comprising generating a report for indicating each alert generated.

9. The method of claim 8, wherein the report is in electronic format.

10. The method of claim 9, wherein the report may be manipulated to facilitate identification of at least one entity responsible for causing the variation.

11. The method of claim 1, wherein the at least one transaction relates to at least one credit card transaction.

12. The method of claim 1, wherein the cost of the transaction relates to an interchange fee.

13. The method of claim 1, wherein the at least one transaction relates to delivery services.

14. The method of claim 1, wherein the at least one transaction relates to parts ordering services.

15. The method of claim 1, wherein the at least one transaction relates to parts fulfillment services.

16. A method for monitoring costs associated with a plurality of transactions completed during a period of time, comprising:
receiving historical qualification cost data relating to costs associated with processing transactions completed before a period of time, wherein the historical data is associated with a plurality of level codes;
receiving current qualification cost data relating to costs associated with processing transactions completed during the period of time, wherein the historical data is associated with a plurality of level codes; and
comparing historical qualification cost data with current qualification cost data for at least one of the level codes to determine whether current transaction costs as compared to historical transaction costs varies by more than a predetermined threshold for at least one of the level codes.

17. The method of claim 16, wherein at least one of the level codes relates to historical qualification cost data and current qualification cost data associated with one or more entities involved in the transaction.

18. The method of claim 17, wherein at least one of the entities were involved in generating the historical qualification cost data or current qualification cost data.

19. The method of claim 17, wherein at least one of the entities were involved in receiving the historical qualification cost data or current qualification cost data.

20. The method of claim 16, wherein at least one of the level codes relates to a location of storage of historical qualification cost data or current qualification cost data.

21. The method of claim 16, wherein at least one of the level codes relates to a location of processing of historical qualification cost data or current qualification cost data.

22. The method of claim 16, wherein at least one of the level codes relates to a manner in which the historical qualification cost data or current qualification cost data were received.

23. The method of claim 16, further comprising generating at least one alert upon determining that the comparison of the historical qualification cost data with current qualification cost data for each of the level codes varies by more than a predetermined threshold for at least one of the level codes.

24. The method of claim 23, further comprising identifying the source of the variation by more than a predetermined threshold based upon identifying the at least one level codes for which the at least one alerts were generated.

25. The method of claim 16, wherein the historical qualification cost data that is compared to the current qualification cost data is qualification cost data generated on a predetermined day of a week for a preceding period of time.

26. The method of claim 23, further comprising generating a report for indicating each alert generated.

27. The method of claim 26, wherein the report is in electronic format.

28. The method of claim 27, wherein the report may be manipulated to facilitate identification of entity causing the variation by more than a predetermined threshold for at least one of the level codes.

29. The method of claim 16, wherein the transactions relates to credit card transactions.

30. The method of claim 16, wherein the historical qualification cost data and the current qualification cost data relate to interchange fees.

31. The method of claim 16, wherein the transactions relate to delivery services.

32. The method of claim 16, wherein the transactions relate to parts ordering services.

33. The method of claim 16, wherein the transactions relate to parts fulfillment services.

34. A method for monitoring efficiency associated with at least one transaction, comprising:
receiving a set of data relating to at least one transaction;
identifying the efficiency of the at least one transaction based on said set of data; and
generating an alert based upon a variation of the efficiency of the transaction as compared to a predefined target transaction efficiency.

35. The method of claim 34, wherein the predefined target transaction efficiency is based upon historical transaction efficiency data.

36. The method of claim 34, wherein the efficiency is measured in terms of time to conduct the at least one transaction.

37. The method of claim 34, wherein the efficiency is measured in terms of cost to conduct the at least one transaction.

38. The method of claim 34, wherein the alert is generated when the variation is greater than a threshold.

39. The method of claim 38, wherein the threshold relates to a predetermined number of transactions for which the associated efficiency varies with the predefined target transaction efficiency.

40. The method of claim 38, wherein the threshold relates to a predetermined minimum amount of variation in efficiency of the at least one transaction as compared to a predefined target transaction efficiency.

41. The method of claim 34, further comprising generating a report for indicating each alert generated.

42. The method of claim 41, wherein the report is in electronic format.

43. The method of claim 42, wherein the report may be manipulated to facilitate identification of at least one entity responsible for causing the variation.

44. The method of claim 34, wherein the at least one transaction relates to at least one credit card transaction.

45. The method of claim 34, wherein the at least one transaction relates to delivery services.

46. The method of claim 34, wherein the at least one transaction relates to parts ordering services.

47. The method of claim 34, wherein the at least one transaction relates to parts fulfillment services.

48. A system for monitoring costs associated with at least one transaction, comprising:
at least one storage device for receiving a set of data relating to at least one transaction; and
at least one processor for identifying the cost of the at least one transaction based on said set of data, and for generating an alert based upon a variation of the cost of the transaction as compared to a predefined target transaction cost.

49. The system of claim 48, wherein the predefined target transaction cost is based upon historical transaction cost data.

50. The system of claim 48, wherein the predefined target transaction cost is based upon an average of transaction cost data for a period of time.

51. The system of claim 50, wherein the average is determined by transaction cost data generated on a predetermined day of a week for the preceding period of time.

52. The system of claim 48, wherein the alert is generated when the variation is greater than a threshold.

53. The system of claim 52, wherein the threshold relates to a predetermined number of transactions for which the associated costs varies with the predefined target transaction cost.

54. The system of claim 52, wherein the threshold relates to a predetermined minimum amount of variation in cost of the at least one transaction as compared to a predefined target transaction cost.

55. The system of claim 48, further comprising an output device for generating a report for indicating each alert generated.

56. The system of claim 55, wherein the report is in electronic format.

57. The system of claim 56, further comprising a user interface device for manipulating the report to facilitate identification of at least one entity responsible for the variation.

58. The system of claim 48, wherein the at least one transaction relates to at least one credit card transaction.

59. The system of claim 48, wherein the cost of the transaction relates to an interchange fee.

60. The system of claim 48, wherein the at least one transaction relates to delivery services.

61. The system of claim 48, wherein the at least one transaction relates to parts ordering services.

62. The system of claim 48, wherein the at least one transaction relates to parts fulfillment services.

63. A system for monitoring costs associated with a plurality of transactions completed during a period of time, comprising:
at least one storage device for receiving historical qualification cost data relating to costs associated with processing transactions completed before a period of time, wherein the historical data is associated with a plurality of level codes, and for receiving current qualification cost data relating to costs associated with processing transactions completed during the period of time, wherein the historical data is associated with a plurality of level codes; and
at least one processor for comparing historical qualification cost data with current qualification cost data for each of the level codes to determine whether current transaction costs as compared to historical transaction costs varies by more than a predetermined threshold for at least one of the level codes.

64. The system of claim 63, wherein at least one of the level codes relates to historical qualification cost data and current qualification cost data associated with one or more entities involved in the transaction.

65. The system of claim 64, wherein at least one of the entities were involved in generating the historical qualification cost data or current qualification cost data.

66. The system of claim 64, wherein at least one of the entities were involved in receiving the historical qualification cost data or current qualification cost data.

67. The system of claim 63, wherein at least one of the level codes relates to a location of storage of historical qualification cost data or current qualification cost data.

68. The system of claim 63, wherein at least one of the level codes relates to a location of processing of historical qualification cost data or current qualification cost data.

69. The system of claim 63, wherein at least one of the level codes relates to a manner in which the historical qualification cost data or current qualification cost data were received.

70. The system of claim 63, wherein the at least one processor is further configured for generating at least one alert upon determining that the comparison of the historical qualification cost data with current qualification cost data for each of the level codes varies by more than a predetermined threshold for at least one of the level codes.

71. The system of claim 70, wherein the at least one processor is further configured for identifying the source of the variation by more than a predetermined threshold based upon identifying the at least one level codes for which the at least one alerts were generated.

72. The system of claim 63, wherein the historical qualification cost data that is compared to the current qualification cost data is qualification cost data generated on a predetermined day of a week for a preceding period of time.

73. The system of claim 70, further comprising an output device for generating a report for indicating each alert generated.

74. The system of claim 73, wherein the report is in electronic format.

75. The system of claim 74, wherein the report may be manipulated to facilitate identification of entity causing the variation by more than a predetermined threshold for at least one of the level codes.

76. The system of claim 63, wherein the transactions relates to credit card transactions.

77. The system of claim 63, wherein the historical qualification cost data and the current qualification cost data relate to interchange fees.

78. The system of claim 63, wherein the transactions relate to delivery services.

79. The system of claim 63, wherein the transactions relate to parts ordering services.

80. The system of claim 63, wherein the transactions relate to parts fulfillment services.

81. A system for monitoring efficiency associated with at least one transaction, comprising:
at least one storage device for receiving a set of data relating to at least one transaction; and
at least one processor for identifying the efficiency of the at least one transaction based on said set of data, and for generating an alert based upon a variation of the efficiency of the transaction as compared to a predefined target transaction efficiency.

82. The system of claim 81, wherein the predefined target transaction efficiency is based upon historical transaction efficiency data.

83. The system of claim 81, wherein the efficiency is measured in terms of time to conduct the at least one transaction.

84. The system of claim 81, wherein the efficiency is measured in terms of cost to conduct the at least one transaction.

85. The system of claim 81, wherein the alert is generated when the variation is greater than a threshold.

86. The system of claim 85, wherein the threshold relates to a predetermined number of transactions for which the associated efficiency varies with the predefined target transaction efficiency.

87. The system of claim 85, wherein the threshold relates to a predetermined minimum amount of variation in efficiency of the at least one transaction as compared to a predefined target transaction efficiency.

88. The system of claim 81, further comprising an output device for generating a report for indicating each alert generated.

89. The system of claim 88, wherein the report is in electronic format.

90. The system of claim 89, further comprising a user interface device for manipulating the report to facilitate identification of at least one entity responsible for causing the variation.

91. The system of claim 81, wherein the at least one transaction relates to at least one credit card transaction.

92. The system of claim 81, wherein the at least one transaction relates to delivery services.

93. The system of claim 81, wherein the at least one transaction relates to parts ordering services.

94. The system of claim 81, wherein the at least one transaction relates to parts fulfillment services.
